(19) United States
(12) Patent Application Publication
(10) Pub. No.: US 2013/0127882 A1
(43) Pub. Date: May 23, 2013

(54) INPUT/OUTPUT DEVICES AND DISPLAY APPARATUSES USING THE SAME

(71) Applicant: HSIANG-CHIA WU, NEW TAIPEI CITY (TW)

(72) Inventor: HSIANG-CHIA WU, NEW TAIPEI CITY (TW)

(73) Assignee: WISTRON CORP., NEW TAIPEI CITY (TW)

(21) Appl. No.: 13/461,734

(22) Filed: May 1, 2012

(30) Foreign Application Priority Data
Nov. 22, 2011 (TW) TW100142658

(51) Int. Cl. G06F 13/14; G06F 15/16

(52) U.S. Cl. 345/502; 710/14

(57) ABSTRACT

An input/output (I/O) device is provided. The I/O device is capable of operating in a first mode or a second mode. The I/O device includes a first connection unit and a switch unit. The first connection unit has a plurality of down-link I/O ports and an up-link I/O port. The switch unit is controlled by a selection signal. The switch unit has an input terminal coupled to the up-link I/O port, a first output terminal, and a second output terminal. When the I/O device is operating in the first mode, the switch unit couples the input terminal to the first output terminal according to the selection signal. When the I/O device is operating in the second mode, the switch unit couples the input terminal to the second output terminal according to the selection signal.

### CROSS REFERENCE TO RELATED APPLICATIONS

This application claims priority of Taiwan Patent Application No. 100142658, filed on Nov. 22, 2011, the entirety of which is incorporated by reference herein.

### BACKGROUND OF THE INVENTION

1. Field of the Invention

The invention relates to an input/output device, and more particularly to an input/output device for display apparatuses.

2. Description of the Related Art

With technological progress development, various types of electronic apparatuses have been provided. Due to the variety of electronic apparatuses, one single platform may include a plurality of apparatuses with different operation systems. If users need to use USB interface external devices for a plurality of operation systems, a plurality of USB hubs are needed for a hot plug operation to performed to the USB interface external devices, which increases costs.

Thus, it is desired to provide an input/output device which can operate in a plurality of modes, so that a plurality of operation systems may be capable of using the external devices through the input/output device.

### BRIEF SUMMARY OF THE INVENTION

An exemplary embodiment of an input/output (I/O) device is provided. The I/O device is capable of operating in a first mode or a second mode. The I/O device includes a first connection unit and a switch unit. The first connection unit has a plurality of down-link I/O ports and an up-link I/O port. The switch unit is controlled by a selection signal. The switch unit has an input terminal coupled to the up-link I/O port, a first output terminal, and a second output terminal. When I/O device operates in the first mode, the switch unit couples the input terminal to the first output terminal according to the selection signal. When the I/O device operates in the second mode, the switch unit couples the input terminal to the second output terminal according to the selection signal.

An exemplarity embodiment of a display apparatus is provided. The display apparatus is externally coupled to a first processing unit. The first processing unit is built with a first operation system and generates a first image signal. The display apparatus includes a second processing unit, a third processing unit built, a display module, a first connection unit, and a switch unit. The second processing unit is built with a second operation system and generates a second image signal. The third processing unit receives the first image signal or the second image signal and generates a display control signal according to the image signal or the second image signal. The display module receives the display control signal and displays images according to the display control signal. The first connection unit has a plurality of down-link I/O ports and an up-link I/O port. The switch unit is controlled by a selection signal. The switch unit has an input terminal coupled to the up-link I/O port, a first output terminal coupled to the first processing unit, and a second output terminal coupled to the second processing unit. When the display apparatus operates in a first mode, the third processing unit generates the display control signal according to the first image signal, and the switch unit couples the input terminal to the first output terminal according to the selection signal. When the display apparatus operates in a second mode, the third processing unit generates the display control signal according to the second image signal, and the switch unit couples the input terminal to the second output terminal according to the selection signal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an exemplary embodiment of an input/output (I/O) device;

FIG. 2A shows one exemplary embodiment of a display apparatus;

FIG. 2B shows another exemplary embodiment of a display apparatus;

FIG. 3 shows a flow chart of one exemplary embodiment of an operation method of a display apparatus;

FIG. 4 shows a flow chart of another exemplary embodiment of an operation method of a display apparatus;

FIG. 5 shows further another exemplary embodiment of a display apparatus;

FIG. 6 shows a flow chart of further another exemplary embodiment of an operation method of a display apparatus; and

FIGS. 7-9 show other exemplary embodiment of a display apparatus.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

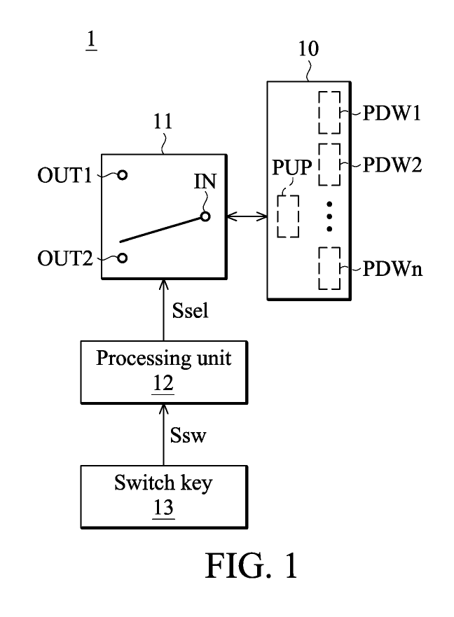

Input/output (I/O) devices are provided. In an exemplary embodiment of an I/O device in FIG. 1, an I/O device 1 is capable of operating at two modes at different times. The I/O device 1 comprises a connection unit 10, a switch unit 11, a processing unit 12, and a switch key 13. In the embodiment, the connection unit 10 is implemented by a universal serial bus hub (USB hub). The USB hub 10 has a plurality of down-link I/O ports PDW1˜PDWn and an up-link IO port PUP. A peripheral device, such as a network card, a touch device, or a card reader, may be coupled to one of the down-link ports ODW1˜PDWn. The switch unit 11 includes an input terminal IN and output terminals OUT1 and OUT2. The switch unit 11 receives a selection signal Ssel. The switch unit 11 is controlled by the selection signal Ssel and couples the input terminal IN to the output terminal OUT1 or OUT2 according to the state of the selection signal Ssel. For example, when the I/O device 1 operates in a first mode, the input terminal IN of the switch unit 11 is coupled to the output terminal OUT1, and when the I/O operates in a second mode, the input terminal IN of the switch unit 11 is coupled to the output terminal OUT2. The processing unit 12 receives a switch signal Ssw. The switch signal Ssw indicates that the I/O device 1 is operating in the first mode or the second mode. The processing unit 12 generates the selection signal Ssel according to the state of the state of the switch signal Ssw to control the switch unit 11 to couple the input terminal IN to the output terminal OUT1 or OUT2. In the embodiment, the states of the switch signal Ssw and the selection Ssel indicate levels of the signals, such as a high level and a low level.

For example, it is assumed that the I/O device 1 is predetermined to operate in the first mode. When the switch signal Ssw has a high level to indicate that the I/O device 1 is operating in a predetermined mode (that is the first mode), the processing unit 12 generates the selection signal Ssel with a low level. At this time, the switch unit 11 couples the input terminal IN to the output terminal OUT1 according to the selection signal Ssw with the low level. When the switch signal Ssw changes to a low level to indicate that the I/O device 1 has been switched to another mode from the predetermined mode (that is, the I/O device 1 has been switched to the second mode from the first mode), the processing unit 12 switches to generate the selection signal Ssel with a high level. At this time, the switch unit 11 couples the input terminal IN to the output terminal OUT2 according to the selection signal Ssel with the high level.

On the contrary, if it is assumed that the I/O device 1 is predetermined to operate in the second mode. When the switch signal Ssw has the high level to indicate that the I/O device 1 is operating in a predetermined mode (that is the second mode), the processing unit 12 generates the selection signal Ssel with the high level. At this time, the switch unit 11 couples the input terminal IN to the output terminal OUT2 according to the selection signal Ssw with the high level. When the switch signal Ssw changes to the low level to indicate that the I/O device 1 has been switched to another mode from the predetermined mode (that is, the I/O device 1 has been switched to the first mode from the second mode), the processing unit 12 switches to generate the selection signal Ssel with the low level. At this time, the switch unit 11 couples the input terminal IN to the output terminal OUT1 according to the selection signal Ssel with the low level.

In the embodiment, the level of the switch signal Ssw is controlled by the switch key 13. For example, the switch key 12 has two switch states. When the switch key 13 is positioned in a first switch state, the switch signal Ssw is at the high level. When the switch key 13 is positioned in a second switch state, the switch signal Ssw is at the low level. In other embodiments, the switch signal Ssw may be generated and changed by a device or unit external to the I/O device 1.

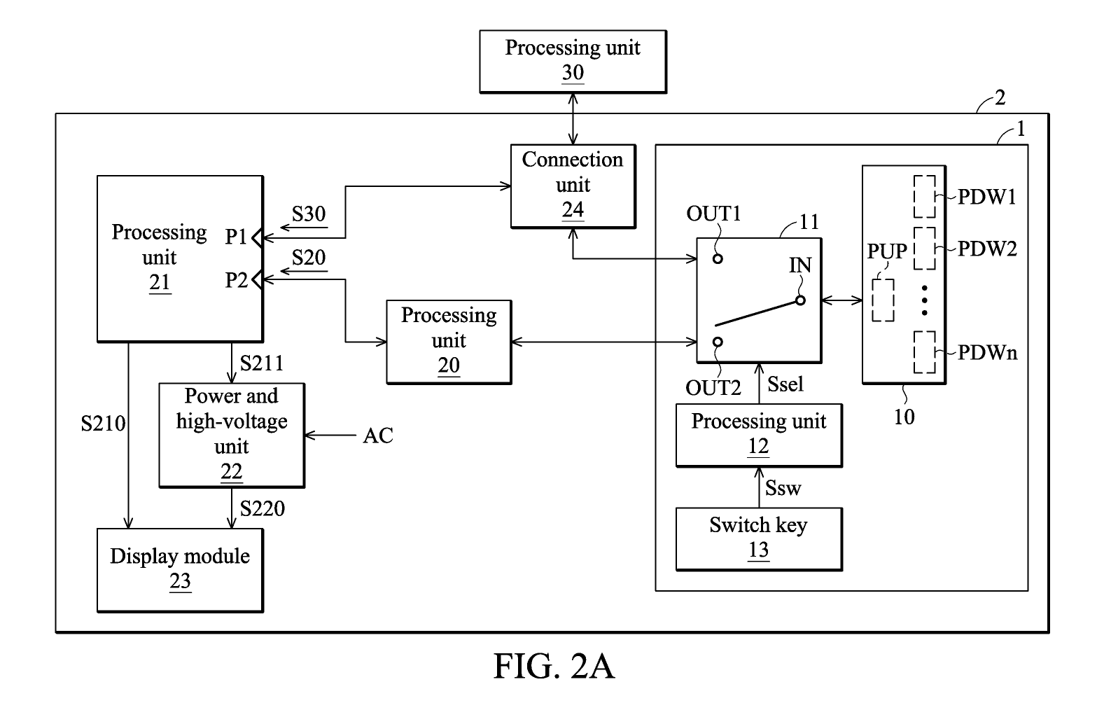

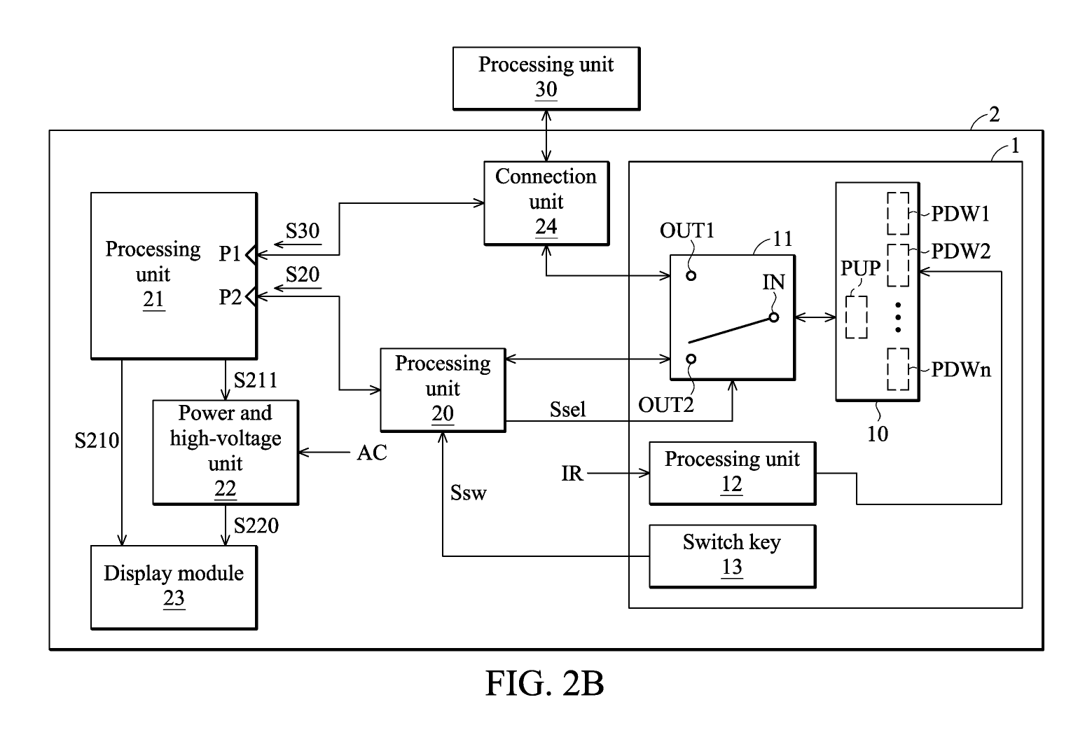

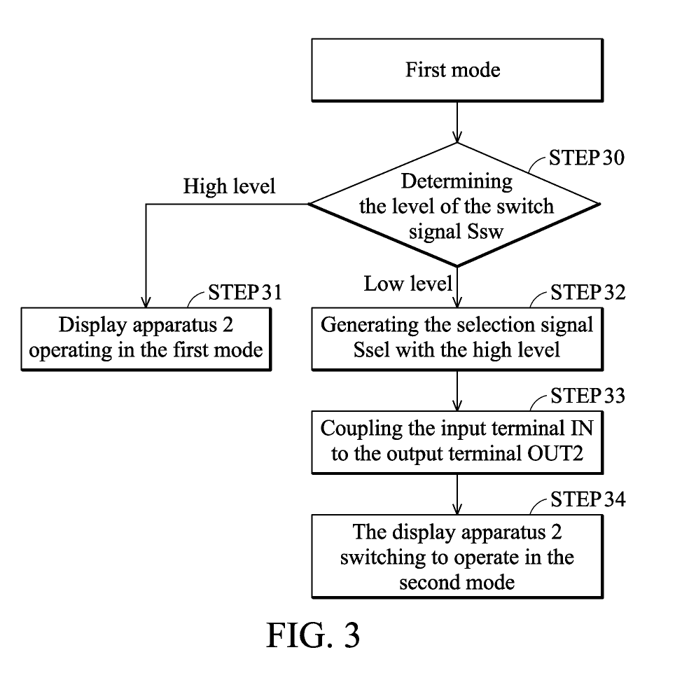

FIG. 2A shows an exemplary embodiment of a display apparatus. Referring to FIG. 3AQ, the I/O device 1 of FIG. 1 is applied to the display apparatus 2 of FIG. 2A. The display apparatus 2 can operate in two modes. The display apparatus 2 comprises not only the I/O device 1 but also processing units 20 and 21, a power and high-voltage unit 22, a display module 23, and a connection unit 24. The structure of the I/O device 1 is illustrated above, thus, related description is omitted here. The processing unit 20 is coupled to the output terminal OUT2 of the switch unit 11 in the I/O device 1 and provides an image signal S20. The output terminal OUT1 of the switch unit 11 in the I/O device 1 is coupled to an external processing unit 30 through the connection unit 24. The processing unit 30 provides an image signal S30. The processing units 20 and 30 are built with different operation systems. In the embodiment, the processing unit 20 is built with an ARM-based system (for example Chromium operation system), and the image signal S20 is generated with a high-definition multimedia interface (HDMI) formation. The external processing unit 30 of the display apparatus 2 is built with a Windows system, and the image signal S30 is generated with a HDMI formation or a video graphics array (VGA) formation. Accordingly, the display apparatus 2 may operate in two different modes, respectively corresponding to the Windows system and the ARM-based system. Since the display apparatus 2 comprises the built-in processing unit 20, the display apparatus 2 is referred to as an apparatus with a built-in system.

The processing unit 21 receives the image signal S20 from the processing unit 20 through an input port P2 of the processing unit 21 or the image signal S30 from the processing unit 30 through an input port P1 thereof. The processing unit 21 generates a display control signal S210 and a backlight control signal S211 according to the image signal S20 or S30. The power and high-voltage unit 22 receives the backlight control signal S211 and an external alternating-current voltage AC and transforms the external alternating-current voltage AC to a backlight driving voltage signal S220 according to the backlight control signal S211. The display module 23 receives the display control signal S210 to determine the image content to be displayed. Moreover, the display module 23 further receives the backlight driving voltage signal S220 to determine the backlight brightness. According to the display control signal S210 and the backlight driving voltage signal S220, the display module 23 displays images corresponding to the image signal S20 or S30.

Except for the backlight driving voltage signal S220 for the display module 23, the power and high-voltage unit 22 further transforms the external alternating-current voltage AC to several direct currents which are provided to the I/O device 1, the processing units 20 and 21, and the display module 23 to serve as respective operation voltages.

In the embodiment, the mode corresponding to the Windows system represents the first mode of the I/O device 1, while the mode corresponding to the ARM-based system represents the second mode thereof.

FIG. 3 shows one exemplary embodiment of an operation method of the display apparatus 2. Referring to FIGS. 2A and 3, it is assumed that the display apparatus 2 is predetermined to operate in the first mode, and the switch unit 11 is predetermined to couple the input terminal IN to the output terminal OUT1 according to the selection signal Ssel with the low level. In the first mode, the processing unit 21 receives the image signal S30 from the processing unit 30 through the connection unit 24 and generates the display control signal S210 and the backlight control signal S211 according to the image signal S30. Moreover, since the switch unit 11 couples the input terminal IN to the output terminal OUT1, the USB hub 10 is controlled by the processing unit 30, and the processing unit 30 may access peripheral devices coupled to the down-link port PDW1˜PDWn. Referring to FIG. 3, first, the processing unit 12 determines the level of the switch signal Ssw (STEP30). When the switch key 13 is positioned in the first switch mode, the processing unit 12 determines that the switch signal Ssw is at the high level. According to the above description, the switch signal Ssw with the high level indicates that the display apparatus 2 is operating in the predetermined mode. Accordingly, the processing unit 12 still generates the selection signal Ssel with the low level, and the switch unit 11 continuously couples the input terminal IN to the output terminal OUT1 according to the selection signal Ssel with the low level. The display apparatus 2 continuously operates in the first mode (STEP31).

When the switch key 13 is positioned in the second switch mode, the processing unit 12 determines that the switch signal Ssw is at the low level. According to the above description, the switch signal Ssw with the low level indicates that the display apparatus 2 has been switched to another mode from the predetermined mode (that is the display apparatus 2 has been switched to the second mode from the first mode). Accordingly, the processing unit 12 switches to generate the selection signal Ssel with the high level (STEP32). The switch unit 11 switches to couple the input terminal IN to the output terminal OUT2 according to the selection signal Ssel with the high level (STEP33). Accordingly, the display apparatus 2 switches to operate in the second mode (STEP34). In the second mode, the processing unit 21 receives the image signal S20 from the processing unit S20 and generates the display control signal S210 and the backlight control signal S211 according to the image signal S20. Further, since the switch unit 11 couples the input terminal IN to the output terminal OUT2, the USB hub 10 is controlled by the processing unit 20, and the processing unit 20 may access peripheral devices coupled to the down-link port PDW1˜PDWn.

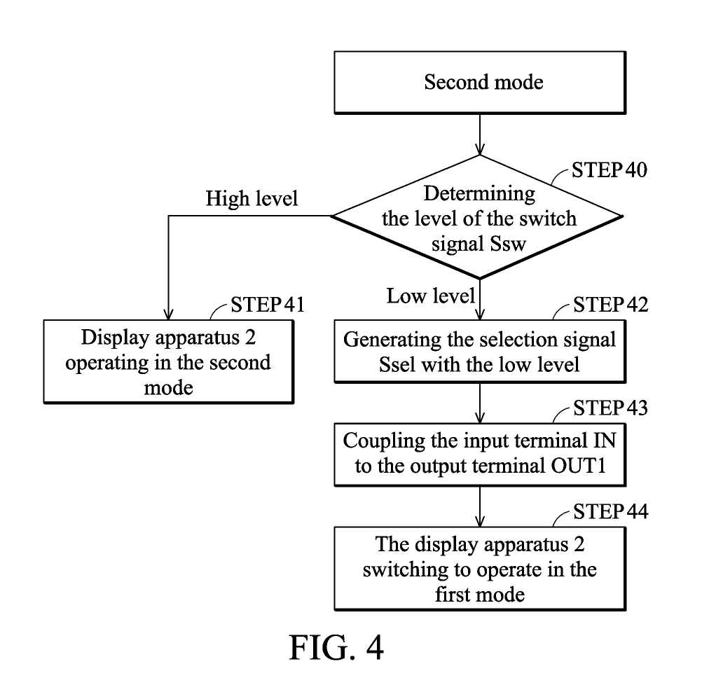

FIG. 4 shows another exemplary embodiment of an operation method of the display apparatus 2. Referring to FIGS. 2A and 4, it is assumed that the display apparatus 2 is predetermined to operate in the second mode, and the switch unit 11 is predetermined to couple the input terminal IN to the output terminal OUT2 according to the selection signal Ssel with the high level. In the second mode, the processing unit 21 receives the image signal S20 from the processing unit 20 and generates the display control signal S210 and the backlight control signal S211 according to the image signal S20. Further, since the switch unit 11 couples the input terminal IN to the output terminal OUT2, the USB hub 10 is controlled by the processing unit 20, and the the processing unit 20 may access peripheral devices coupled to the down-link port PDW1˜PDWn. Referring to FIG. 4, first, the processing unit 21 determines the level of the switch signal Ssw (STEP40). When the switch key 13 is positioned in the first switch mode, the processing unit 12 determines that the switch signal Ssw is at the high level to indicate that the display apparatus 2 is operating in the predetermined mode. Accordingly, the processing unit 12 still generates the selection signal Ssel with the low level, and the switch unit 11 continuously couples the input terminal IN to the output terminal OUT2 according to the selection signal Ssel with the high level. The display apparatus 2 continuously operates in the second mode (STEP41).

When the switch key 13 is positioned in the second switch mode, the processing unit 12 determines that the switch signal Ssw is at the low level to indicate that the display apparatus 2 has been switched to another mode from the predetermined mode (that is the display apparatus 2 has been switched to the first mode from the second mode). Accordingly, the processing unit 12 switches to generate the selection signal Ssel with the low level (STEP42). The switch unit 11 switches to couple the input terminal IN to the output terminal OUT1 according to the selection signal Ssel with the low level (STEP43). Accordingly, the display apparatus 2 switches to operate in the first mode (STEP44). In the first mode, the processing unit 21 receives the image signal S30 from the processing unit 30 through the connection unit 24 and generates the display control signal S210 and the backlight control signal S211 according to the image signal S30. Further, since the switch unit 11 couples the input terminal IN to the output terminal OUT1, the USB hub 10 is controlled by the processing unit 30, and the the processing unit 30 may access peripheral devices coupled to the down-link port PDW1˜PDWn.

In the above embodiment, the state of the switch unit Ssw (that is the level of the switch signal Ssw) is determined by the processing unit 12. In other embodiments, the state of the switch signal Ssw may be determined by the processing unit 20. The processing unit 20 generates the selection signal Ssel according to the determination result to control the switch unit 11 to couple the input terminal IN to the output terminal OUT1 or OUT2. As shown in FIG. 2B, the processing unit 20 receives the switch signal Ssw and determines the state of the switch signal Sse by the same operation as the processing unit 21, thus, related description is omitted here. In this case, the processing unit 12 may process other signal processes. For example, the processing unit 12 receives an infrared ray signal IR from a remote control, as shown in FIG. 2B. The processing unit 12 then converts the infrared ray signal IR to a signal with a USB specification and provides the signal to one of the down-link ports, such as the down-link port PDW2.

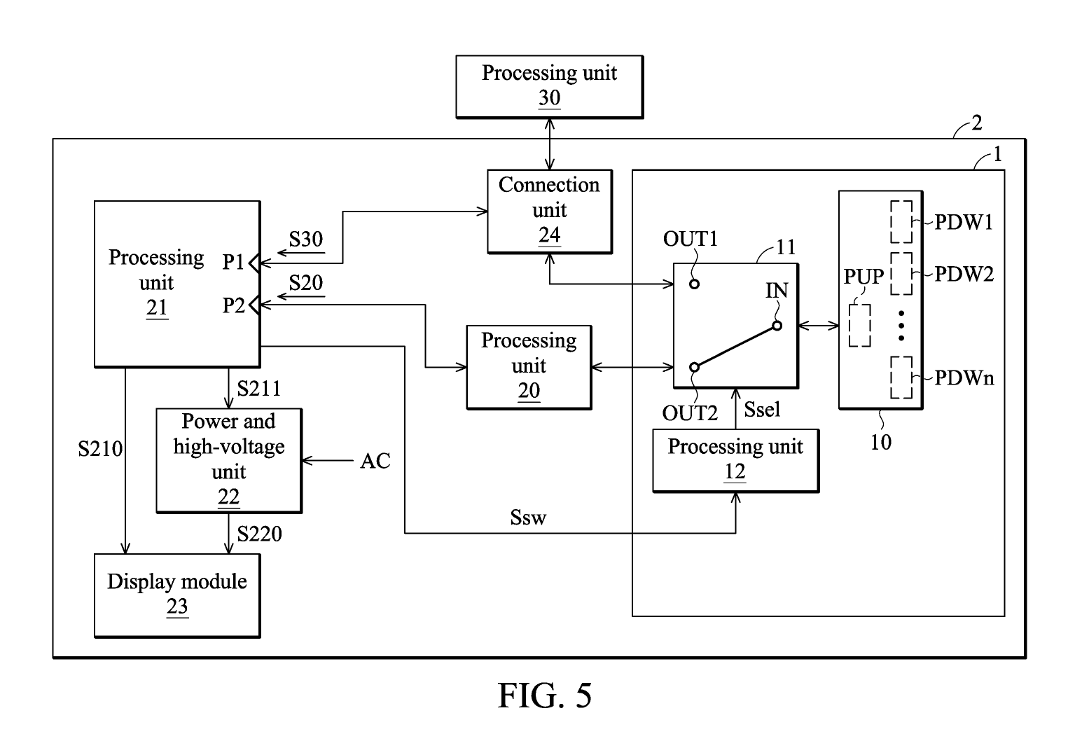

In other embodiments, the switch signal Ssw is generated and changed by the processing unit 21. As shown in FIG. 5, in the embodiment of FIG. 5, the I/O device 1 does not comprise the switch key 13. In further other embodiments, the I/O device 1 still comprises the switch key, but the function of the switch key is disabled.

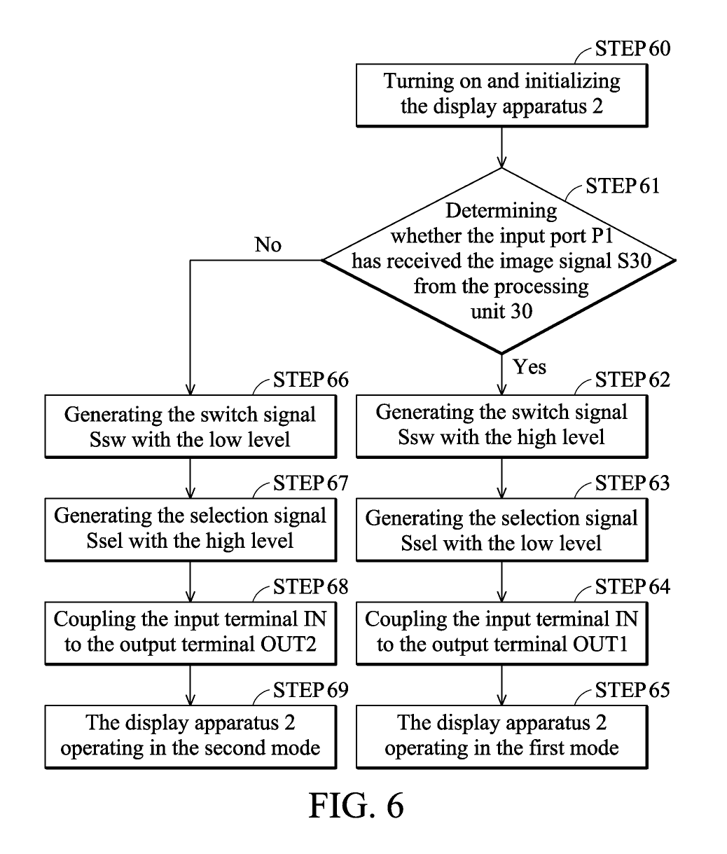

FIG. 6 shows another exemplary embodiment of an operation method of the display apparatus 2. Referring to FIGS. 5 and 6, it is assumed that the display apparatus 2 is predetermined to operate in the first mode. First, the display apparatus 2 is turned on and initialized (STEP60). Since the predetermined mode is the first mode, after initialization, the processing unit 21 determines whether the input port P1 has received the image signal S30 from the processing unit 30 (STEP61). For the case where the processing unit 21 determines that the input port P1 has received the image signal S30 from the processing unit 30 according to the determination result of the step STEP61, the processing unit 30 is coupled to the display apparatus 2 through the connection unit 24 and provides the image signal S30. For the case where the processing unit 21 determines that the input port P1 has not received the image signal S30 from the processing unit 30, the processing unit 30 is not coupled to the display apparatus 2 through the connection unit 24 and that the input port P1 can not receive the image signal S30.

Thus, in the step STEP61, when the processing unit 21 determines that the input port P1 has received the image signal S30 from the processing unit 30, the processing unit 21 generates the switch signal Ssw with the high level (STEP62). According to the above description, the switch signal Ssw with the high level indicates that the display apparatus 2 is operating in the predetermined mode. Accordingly, the processing unit 12 generates the selection signal Ssel with the low level (STEP63), and the switch unit 11 couples the input terminal IN to the output terminal OUT1 according to the selection signal Ssel with the low level (STEP64). The display apparatus 2 operates in the first mode (STEP65). In the first mode, the processing unit 21 receives the image signal S30 from the processing unit 30 through the input port P1 and generates the display control signal S210 and the backlight control signal S211 according to the image signal S30. Moreover, since the switch unit 11 couples the input terminal IN to the output terminal OUT1, the USB hub 10 is controlled by the processing unit 30, and the processing unit 30 may access peripheral devices coupled to the down-link port PDW1˜PDWn.

In the step STEP61, when the processing unit 21 determines that the input port P1 has not received the image signal S30 from the processing unit 30, the processing unit 21 generates the switch signal Ssw with the low level (STEP66). According to the above description, the switch signal Ssw with the low level indicates that the display apparatus 2 has been switched to another mode from the predetermined mode (that is the display apparatus 2 has been switched to the second mode from the first mode). Accordingly, the processing unit 12 switches to generate the selection signal Ssel with the high level (STEP67), and the switch unit 11 switches to couple the input terminal IN to the output terminal OUT2 according to the selection signal Ssel with the high level (STEP68). The display apparatus 2 operates in the second mode (STEP69). In the second mode, the processing unit 21 receives the image signal S20 from the processing unit S20 through the input port P2 and generates the display control signal S210 and the backlight control signal 5211 according to the image signal S20. Further, since the switch unit 11 couples the input terminal IN to the output terminal OUT2, the USB hub 10 is controlled by the processing unit 20, and the processing unit 20 may access peripheral devices coupled to the down-link port PDW1˜PDWn.

According to the above embodiments, the USB hub 10 is controlled by two processing units, particularly, by two processing units with different operation systems. When the USB hub 10 is applied to the display apparatus 2, through the processing unit 21 and the switch operation of the switch unit 11, the usage right of the USB hub 10 may be switched to be controlled by the internal processing unit 20 of the display apparatus 20 or the external processing unit 30 of the display apparatus 20.

In the embodiments of FIGS. 2A, 2B, and 5, the display apparatus 2 is given as an example of a non-self-luminous display apparatus. That is, the display module 23 of the display apparatus 2 comprises a backlight unit to provide light required for displayed images, such as liquid crystal display apparatuses. Thus, in the embodiments of FIGS. 2A, 2B, and 5, the processing unit 21 generates the backlight control signal S211 according to the image signal S20 or S30. The power and high-voltage 22 transforms the external alternating-current voltage AC to the backlight driving voltage signal S220 according to the backlight control signal S211 to determine the brightness of the light provided by the backlight unit (that is the backlight brightness).

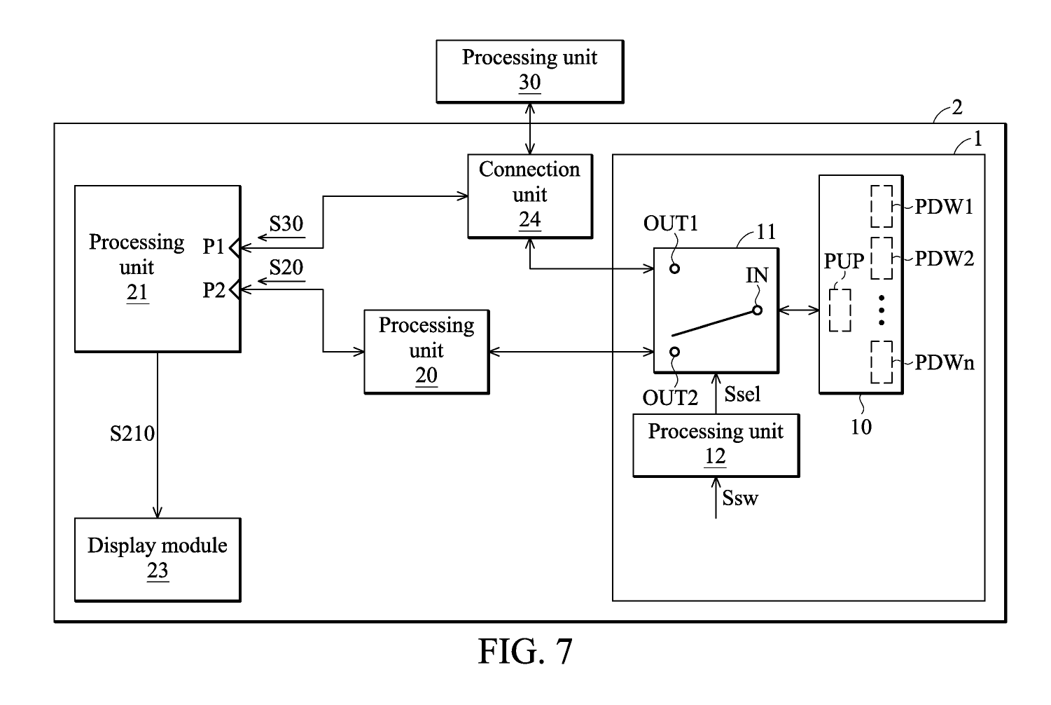

In other embodiments, the display apparatus 2 may be implemented by a self-luminous display apparatus. That is, the display module 23 of the display apparatus 2 may not comprise a backlight unit to provide light required for displayed image, for example, an organic light-emitting diode (OLED) display apparatus. Referring to FIG. 7, compared with the display apparatus 2 shown in FIG. 2A, the display apparatus 2 shown in FIG. 7 does not comprises the power and high-voltage unit 22. Thus, in the embodiment of FIG. 7, the processing unit 21 is not required to generate the backlight control signal S211. Except for the power and high-voltage unit 22 and the generation of the backlight control signal 5211, the structure of the display apparatus 2 shown in FIG. 7 is the same as the structure of the display apparatus 2 shown in FIG. 2A, and the same elements are represented by the same element symbols and perform the same operations.

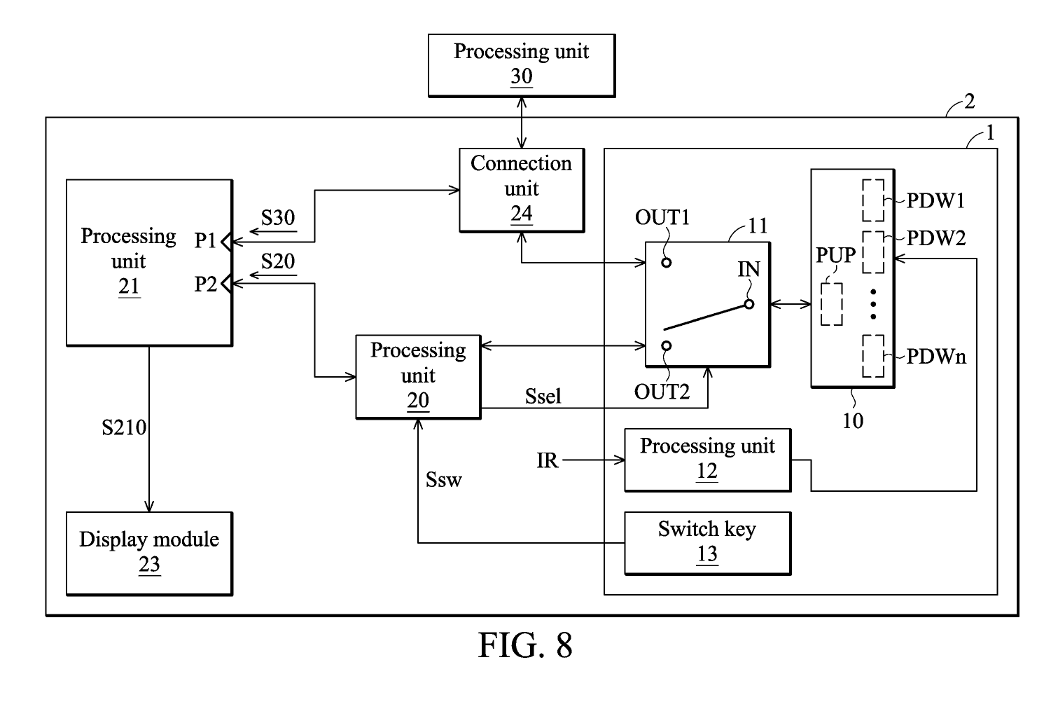

Similarly, referring to FIG. 8, compared with the display apparatus 2 shown in FIG. 2B, the display apparatus 2 shown in FIG. 8 does not comprises the power and high-voltage unit 22. Thus, in the embodiment of FIG. 8, the processing unit 21 is not required to generate the backlight control signal S211. Except for the power and high-voltage unit 22 and the generation of the backlight control signal S211, the structure of the display apparatus 2 shown in FIG. 8 is the same as the structure of the display apparatus 2 shown in FIG. 2B, and the same elements are represented by the same element symbols and perform the same operations.

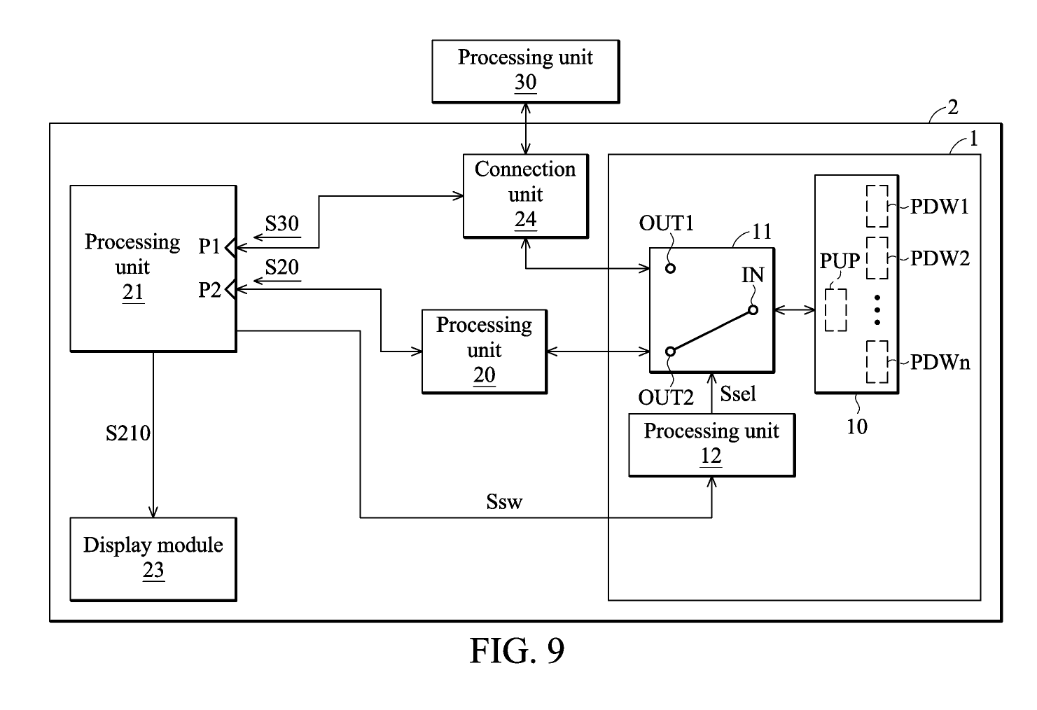

Similarly, referring to FIG. 9, compared with the display apparatus 2 shown in FIG. 5, the display apparatus 2 shown in FIG. 9 does not comprise the power and high-voltage unit 22. Thus, in the embodiment of FIG. 9, the processing unit 21 is not required to generate the backlight control signal S211. Except for the power and high-voltage unit 22 and the generation of the backlight control signal S211, the structure of the display apparatus 2 shown in FIG. 9 is the same as the structure of the display apparatus 2 shown in FIG. 5, and the same elements are represented by the same element symbols and perform the same operations.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An input/output (I/O) device being capable of operating in a first mode or a second mode comprising:
a first connection unit having a plurality of down-link I/O ports and an up-link I/O port; and
a switch unit controlled by a selection signal, having an input terminal coupled to the up-link I/O port, and having a first output terminal and a second output terminal;
wherein when the I/O device operates in the first mode, the switch unit couples the input terminal to the first output terminal according to the selection signal; and
wherein when the I/O device operates in the second mode, the switch unit couples the input terminal to the second output terminal according to the selection signal.

2. The I/O device as claimed in claim 1 further comprising:
a first processing unit for receiving a switch signal which indicates that the I/O device is operating in the first mode or the second mode, and for generating the selection signal according to a state of the switch signal to control the switch unit to couple the input terminal to the first output terminal or the second output terminal.

3. The I/O device as claimed in claim 1 further comprising:
a switch key for changing the state of the switch signal.

4. The I/O device as claimed in claim 1, wherein the first output terminal of the switch unit is coupled to a second processing unit built with a first operation system, and the second output terminal of the switch unit is coupled to a third processing unit built with a second operation system.

5. The I/O device as claimed in claim 4, wherein the first operation system is a Windows system, and the second operation system is a Linux system.

6. The I/O device as claimed in claim 1, wherein the first connection unit is a universal serial bus (USB) hub.

7. A display apparatus externally coupled to a first processing unit, wherein the first processing unit is built with a first operation system and generates a first image signal, and the display apparatus comprises:
a second processing unit built with a second operation system, the second processing unit for generating a second image signal;
a third processing unit for receiving the first image signal or the second image signal, and for generating a display control signal according to the image signal or the second image signal;
a display module for receiving the display control signal and for displaying images according to the display control signal;
a first connection unit having a plurality of down-link I/O ports and an up-link I/O port; and
a switch unit controlled by a selection signal and having an input terminal coupled to the up-link I/O port, a first output terminal coupled to the first processing unit, and a second output terminal coupled to the second processing unit;
wherein when the display apparatus operates in a first mode, the third processing unit generates the display control signal according to the first image signal, and the switch unit couples the input terminal to the first output terminal according to the selection signal; and
wherein when the display apparatus operates in a second mode, the third processing unit generates the display control signal according to the second image signal, and the switch unit couples the input terminal to the second output terminal according to the selection signal.

8. The display apparatus as claimed in claim 7, wherein the second processing unit receives a switch signal which indicates that the display apparatus is operating in the first mode or the second mode and generates the selection signal according to a state of the switch signal to control the switch unit to couple the input terminal to the first output terminal or the second output terminal;
wherein the display apparatus further comprises a switch key to change the state of the switch signal.

9. The display apparatus as claimed in claim 7 further comprising:
a fourth processing unit for receiving a switch signal which indicates that the display apparatus is operating in the first mode or the second mode, and for generating the selection signal according to a state of the switch signal to control the switch unit to couple the input terminal to the first output terminal or the second output terminal; and
a switch key for changing the state of the switch signal.

10. The display apparatus as claimed in claim 7 further comprising:
a fourth processing unit for receiving a switch signal which indicates that the display apparatus is operating in the first mode or the second mode, and for generating the selection signal according to a state of the switch signal to control the switch unit to couple the input terminal to the first output terminal or the second output terminal;
wherein when the display apparatus is turned on and initialized, the third processing unit determines whether the first image signal has been received and changes the state of the switch signal according to the determination result.

11. The display apparatus as claimed in claim 10, wherein when the third processing unit determines that the first image signal has been received, the third processing unit generates the switch signal to indicate that the display apparatus is operating in the first mode, and the fourth processing unit generates the selection signal according to the switch signal to control the switch unit to couple the input terminal to the first output terminal.

12. The display apparatus as claimed in claim 11, wherein when the third processing unit determines that the first image signal has not been received, the third processing unit generates the switch signal to indicate that the display apparatus is operating in the second mode, and the fourth processing unit generates the selection signal according to the switch signal to control the switch unit to couple the input terminal to the second output terminal.

13. The display apparatus as claimed in claim 10, wherein the first image signal is generated with a high-definition multimedia interface (HDMI) formation or a video graphics array (VGA) formation.

14. The display apparatus as claimed in claim 7 further comprising a second connection unit,
wherein the first output terminal of the switch unit is coupled to the first processing unit through the second connection unit.

15. The display apparatus as claimed in claim 7, wherein the first operation system is a Windows system, and the second operation system is a Linux system.

16. The display apparatus as claimed in claim 7, wherein the first connection unit is a universal serial bus (USB) hub.

17. The display apparatus as claimed in claim 7, wherein the third processing unit further generates a backlight control signal according to the first image signal or the second image signal, and the display apparatus further comprises:
a power and high-voltage unit for receiving the backlight control signal and for generating a backlight driving voltage signal according to the backlight control signal;
wherein the display module further receives the backlight driving voltage signal and displays images according to the display control signal and the backlight driving voltage signal.
